(19) United States
(12) Patent Application Publication
(10) Pub. No.: US 2023/0408448 A1
(43) Pub. Date: Dec. 21, 2023

(54) EDDY CURRENT MEASUREMENT AND ANALYSIS FOR THE DETECTION OF GRINDING BURNS ON HIGH STRENGTH STEEL THROUGH CHROME PLATING

(71) Applicant: SOUTHWEST RESEARCH INSTITUTE, San Antonio, TX (US)

(72) Inventors: Clinton J. Thwing, Bulverde, TX (US); Teodor DOGARU, Ellicot City, MD (US); Nathan D. RICHTER, San Antonio, TX (US)

(21) Appl. No.: 17/844,528

(22) Filed: Jun. 20, 2022

(51) Int. Cl. G01N 27/90; G01N 27/9093

(52) U.S. Cl. CPC G01N 27/9006; G01N 27/9093

(57) ABSTRACT

In an approach to detection of grinding burns on high strength steel through chrome plating comprising: a frequency generator device; a scanning device; one or more computer processors; one or more non-transitory computer readable storage media; and program instructions stored on the one or more non-transitory computer readable storage media for execution by at least one of the one or more computer processors, the stored program instructions including instructions to: calibrate the system; inject a low frequency signal into a Device Under Test (DUT); scan the DUT and receive a resulting eddy current (EC) signal response; extract one or more real components and one or more imaginary components of the resulting EC signal response; and perform a phase rotation on the one or more orthogonal components of the resulting EC signal response to highlight one or more effects of interest.

### STATEMENT REGARDING FEDERALLY SPONSORED RESEARCH OR DEVELOPMENT

This invention was made with government support under FA864922P0457 awarded by the United States Air Force. The government has certain rights in the invention.

### TECHNICAL FIELD

The present application relates generally to non-destructive testing and, more particularly, to a system and method for eddy current measurement and analysis for the detection of grinding burns on high strength steel through chrome plating.

### BACKGROUND

Eddy currents are loops of electrical current induced within conductors by a changing magnetic field in the conductor. Eddy currents flow in closed loops within conductors, in planes perpendicular to the magnetic field. They can be induced within nearby stationary conductors by a time-varying magnetic field created by, for example, an alternating current (AC) electromagnet or transformer or by relative motion between a magnet and a nearby conductor. The magnitude of the current in a given loop is proportional to the strength of the magnetic field, the area of the loop, and the rate of change of flux, and inversely proportional to the resistivity of the material. When graphed, these circular currents within a piece of metal look vaguely like eddies or whirlpools in a liquid.

Eddy currents refer to electrical currents that are produced in a material as part of a process of magnetic induction. Alternating current flowing in a coil placed above the material generates a magnetic field that penetrates the material surface. This magnetic field causes the material to generate an opposing loop of current with its own magnetic field in opposition to the original magnetic field. Material properties, such as conductivity and magnetic permeability, affect this system and influence the signal that is generated as the coil measures different points on the material. These signal changes are interpreted as changes in resistivity and reactivity of the material and are best viewed on the complex plane. Geometric attributes of the material, such as cracks and liftoff can also affect the apparent resistivity or reactivity of the material being measured.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a distributed data processing environment consistent with the present disclosure.

FIG. 2 is one exemplary flow diagram of a system for eddy current measurement and analysis for the detection of grinding burns on high strength steel through chrome plating, consistent with the present disclosure.

FIG. 3A is an example graph of the real components of an eddy current response for a chrome plated steel specimen, consistent with the present disclosure.

FIG. 3B is an example graph of the imaginary components of an eddy current response for a chrome plated steel specimen, consistent with the present disclosure.

FIG. 4A is an example comparing probe outputs before and after chrome plating, consistent with the present disclosure.

FIG. 4B is an example comparing the results of FIG. 4A to a destructive Nital etch result.

FIG. 5 is a flowchart diagram depicting operations for the burn detection program, for eddy current measurement and analysis for the detection of grinding burns on high strength steel through chrome plating, on the distributed data processing environment of FIG. 1, consistent with the present disclosure.

FIG. 6 is a block diagram depicting components of one example of the computing device suitable for burn detection program, within the distributed data processing environment of FIG. 1, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

Metallurgical burns on chrome-plated high strength steel, for example, the material commonly used in aircraft landing gear, are sometimes seen during the teardown and repair process. Because these burns are present on the surface of the underlying steel, they are only visible after the chrome has been removed during service intervals. The presence of metallographic burns can severely decrease the fatigue life of chrome plated high strength steel. Because these burns are covered by chrome while the part is in service, it is not possible to evaluate metallographic damage without a method that examines beneath the chrome layer.

The ability to directly sense burn damage through chrome is of benefit to anyone who wants to detect burns on high strength steel through chrome. Given there is evidence that burns severely decrease the fatigue life of high strength steels, inspectors want to validate that a part has been ground correctly and can be loaded to its expected capacity without failure. This validation process eliminates the need to trust that the grinding process was conducted correctly, as there may be unexpected variations in the process that result in burns.

Currently there are several methods for determining burns on steel, but only one can detect them nondestructively through chrome. Destructive methods involve sectioning the steel and conducting hardness measurements and microstructural analysis on the exposed face. In the case of bare steel, burn location and type may be evaluated with a Nital etch (considered a destructive method) which produces a discoloration based on the type of burn present. Burns may be detected through chrome using Barkhausen Noise Analysis, which measures a noise-like signal that is induced into the steel with an applied magnetic field. Barkhausen Noise Analysis is considered a well-established means of detecting burns both on parts with and without chrome; however, the high cost of the instrument and the requirement of highly skilled and specialized technicians to use it means it is often unwieldy to implement on a large scale.

Burn types can come in two groups, overtempered (OT) and rehardened (RH) burns. In the OT case, elevated temperatures past the tempering temperature result in a softening of the steel, which also results in an increase in magnetic permeability. In the case of RH burns, elevated temperatures past the austenitization point results in a hardening of the steel and a lower permeability compared to an OT region. Given that RH burns require higher temperatures than OT burns, and temperature changes in a material during grinding are continuous, RH burns will be surrounded by some degree of OT burning.

Eddy current (EC) testing can be used to detect the permeability changes caused by metallographic burns because it is sensitive to changes in magnetic permeability. The detection of burn damage is complicated by the presence of chrome, which causes liftoff of the probe and obfuscates the results of high frequency EC due to the presence of microcracks throughout the chrome layer. There exists a need to differentiate RH and OT regions from normal steel through chrome, even when microcracks are present in the chrome. The system disclosed herein addresses that need.

Eddy currents refer to electrical currents that are produced in a material as part of the process of magnetic induction. Alternating current flowing in a coil placed above the material generates a magnetic field that penetrates the material surface. This magnetic field causes the material to generate an opposing loop of current with its own magnetic field in opposition to the original magnetic field. Material properties, such as conductivity and magnetic permeability, affect this system and influence the signal that is generated as the coil measures different points on the material. These signal changes are interpreted as changes in resistivity and reactivity of the material and are best viewed on the complex plane. Geometric attributes of the material, such as cracks and liftoff, can also affect the apparent resistivity or reactivity of the material being measured.

As multiple parameters can affect the apparent resistivity and reactivity of the measured material, care must be taken to separate signals of interest from spurious signals. This is done through manipulation of the complex plane the EC response is plotted on. By rotating the complete EC response and viewing either the real or imaginary component, unwanted effects can be eliminated while effects of interest are highlighted.

As the distance away from the driving coil increases, the density of EC decreases exponentially. The result is that a change in material properties further away from the driving coil affects the resulting signal less than if the same change were close to the coil. EC alternating at lower frequencies is able to penetrate deeper into the material without being dissipated, allowing properties further away from the coil to be measured more easily. In the case of an object that is comprised of more than one layer of materials of differing properties, a lower frequency can be chosen so that the relative effect of the first layer on the EC signal is decreased, allowing easier detection of changes in deeper layers.

The system disclosed herein uses an EC probe operating at low frequencies to penetrate the chrome layer and generate a larger portion of EC in the steel layer than would be possible at higher frequencies. Due to the high magnetic permeability of steel compared to nonmagnetic chrome, the EC that does penetrate the chrome becomes concentrated at the steel surface, making it sensitive to surface changes. Additionally, because an OT burn increases magnetic permeability relative to unburned steel while an RH burn decreases magnetic permeability relative to the OT steel, differentiation of the two burns is more easily detected. The portion of EC density that remains in the chrome is sensitive to the series of microcracks that permeate the layer. Part of the disclosed system requires the EC response to be rotated in such a way that the response attributed to cracking is mostly restricted to one axis, while the response from the underlying steel is restricted to the other axis. The result of this process is illustrated in FIGS. 3A and 3B below, where the response from cracking is restricted to the real axis, as shown in the graph of FIG. 3A, while the response from permeability changes in the steel appear on the imaginary axis, as shown in the graph of FIG. 3B.

Eddy currents are more concentrated at the surface and decrease in intensity with distance below the surface of the metal. This effect is known as the “skin effect.” The depth at which eddy current density has decreased to 1/e, where e is Euler's number or the base of the natural logarithms, or about 37% of the surface density, is called the standard depth of penetration. Eddy currents decrease rapidly with depth; for example, at two standard depths of penetration, the eddy current density has decreased to 1/e squared or 13.5% of the surface density, while at three depths of penetration, the eddy current density is down to only 5% of the surface density.

The depth of penetration is dependent on the frequency of the injected test signal, the conductivity and magnetic permeability of the material under test. The depth of penetration decreases with increasing frequency, conductivity, and permeability. Since the sensitivity of an inspection depends on the eddy current density at the defect location, it is important to know the strength of the eddy currents at this location. When attempting to locate flaws, a frequency is often selected which places the expected flaw depth within one standard depth of penetration. This helps to assure that the strength of the eddy currents will be sufficient to produce a flaw indication.

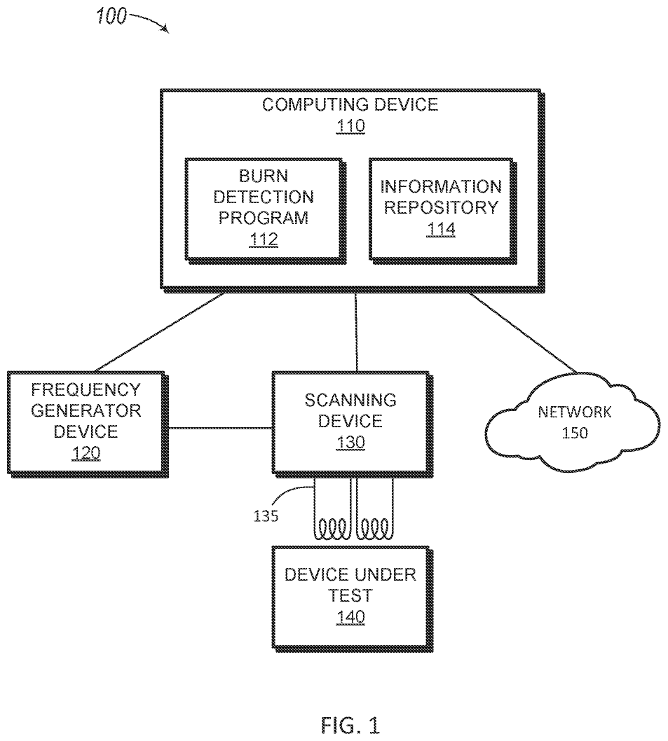

FIG. 1 is a functional block diagram illustrating a distributed data processing environment, generally designated 100, suitable for operation of the burn detection program 112 consistent with the present disclosure. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 100 includes computing device 110 optionally connected to network 150. Network 150 can be, for example, a telecommunications network, a local area network (LAN), a wide area network (WAN), such as the Internet, or a combination of the three, and can include wired, wireless, or fiber optic connections. Network 150 can include one or more wired and/or wireless networks that are capable of receiving and transmitting data, voice, and/or video signals, including multimedia signals that include voice, data, and video information. In general, network 150 can be any combination of connections and protocols that will support communications between computing device 110 and other computing devices (not shown) within distributed data processing environment 100.

Computing device 110 can be a standalone computing device, a management server, a web server, a mobile computing device, or any other electronic device or computing system capable of receiving, sending, and processing data. In an embodiment, computing device 110 can be a personal computer (PC), a desktop computer, a laptop computer, a tablet computer, a netbook computer, a smart phone, or any programmable electronic device capable of communicating with other computing devices (not shown) within distributed data processing environment 100 via network 150. In another embodiment, computing device 110 can represent a server computing system utilizing multiple computers as a server system, such as in a cloud computing environment. In yet another embodiment, computing device 110 represents a computing system utilizing clustered computers and components (e.g., database server computers, application server computers) that act as a single pool of seamless resources when accessed within distributed data processing environment 100.

In an embodiment, computing device 110 includes burn detection program 112. In an embodiment, burn detection program 112 is a program, application, or subprogram of a larger program for the detection of grinding burns on high strength steel through chrome plating. In an alternative embodiment, burn detection program 112 may be located on any other device accessible by computing device 110 via network 150.

In an embodiment, computing device 110 includes information repository 114. In an embodiment, information repository 114 may be managed by burn detection program 112. In an alternate embodiment, information repository 114 may be managed by the operating system of the computing device 110, alone, or together with, burn detection program 112. Information repository 114 is a data repository that can store, gather, compare, and/or combine information. In some embodiments, information repository 114 is located externally to computing device 110 and accessed through a communication network, such as network 150. In some embodiments, information repository 114 is stored on computing device 110. In some embodiments, information repository 114 may reside on another computing device (not shown), provided that information repository 114 is accessible by computing device 110. Information repository 114 includes, but is not limited to, system data, calibration data, signal data, eddy current data, real component data, imaginary component data, and other data that is received by burn detection program 112 from one or more sources, and data that is created by burn detection program 112.

Information repository 114 may be implemented using any non-transitory volatile or non-volatile storage media for storing information, as known in the art. For example, information repository 114 may be implemented with random-access memory (RAM), solid-state drives (SSD), one or more independent hard disk drives, multiple hard disk drives in a redundant array of independent disks (RAID), optical library, or a tape library. Similarly, information repository 114 may be implemented with any suitable storage architecture known in the art, such as a relational database, an object-oriented database, or one or more tables.

Distributed data processing environment 100 includes the Device Under Test (DUT) 140, which is the part to be examined for the detection of grinding burns through chrome plating. In a typical example, the DUT 140 is a part that consists primarily of high strength steel with a chrome plating over the steel.

Distributed data processing environment 100 includes frequency generator device 120 communicatively coupled to computing device 110. In some embodiments, frequency generator device 120 is a frequency generator capable of generating low frequency alternating current (AC) signals to induce eddy currents in the DUT.

In some embodiments, the frequency of the low frequency signals are dependent on the thickness of the outer layer of material, e.g., chrome, and are in the range of about 5 kilohertz (kHz) to 100 kHz. For example, for a plating of chrome with a depth of about 3 thousandths of an inch (3 mil), the frequency generator 120 would be adjusted to generate a frequency in the range of about 30 kilohertz (kHz) to about 100 kHz.

Distributed data processing environment 100 includes scanning device 130 communicatively coupled to computing device 110. In some embodiments, scanning device 130 is a scanning system capable of moving a probe around the complete DUT and capturing the eddy currents from the DUT, along with the coordinates of each sample on the DUT.

In some embodiments, scanning device 130 is an automated scanning system to improve the quality of the measurements and to construct images of scanned areas. The automated scanning system of scanning device 130 may use line scanning where an automated system is used to push the probe at a fixed speed. The advantage of using a linear scanning system is that the probe is moved at a constant speed, so indications in the data can be correlated to a position on the part being scanned.

In some embodiments, scanning device 130 is a two-dimensional scanning system, which is used to scan a two-dimensional area. For example, scanning device 130 may be a scanning system that scans over a relatively flat area in a X-Y raster mode.

In some embodiments, scanning device 130 includes EC probe 135. In the example illustrated in FIG. 1, EC probe 135 is a reflection probe. A reflection probe has two coils, where one coil is used to excite the eddy currents and the other coil is used to sense changes in the test material. In some embodiments, EC probe 135 may be a differential probe. Differential probes have two active coils usually wound in opposition. When one coil is over a defect and the other is over good material, a differential signal is produced. In yet other embodiments, EC probe 135 may be a hybrid probe. A hybrid probe, for example, a split D probe, has a driver coil that surrounds two D shaped sensing coils. It operates in the reflection mode but additionally, its sensing coils operate in the differential mode. In some other embodiments, EC probe 135 may be any other type of EC probe as would be known to a person of skill in the art.

In some other embodiments, scanning device 130 is an EC probe, e.g., EC probe 135, capable of capturing the eddy currents from the DUT as a user moves the probe around the DUT. In yet other embodiments, scanning device 130 may be any system or device capable of scanning the DUT to capture eddy currents and communicate the captured signals to computing device 110.

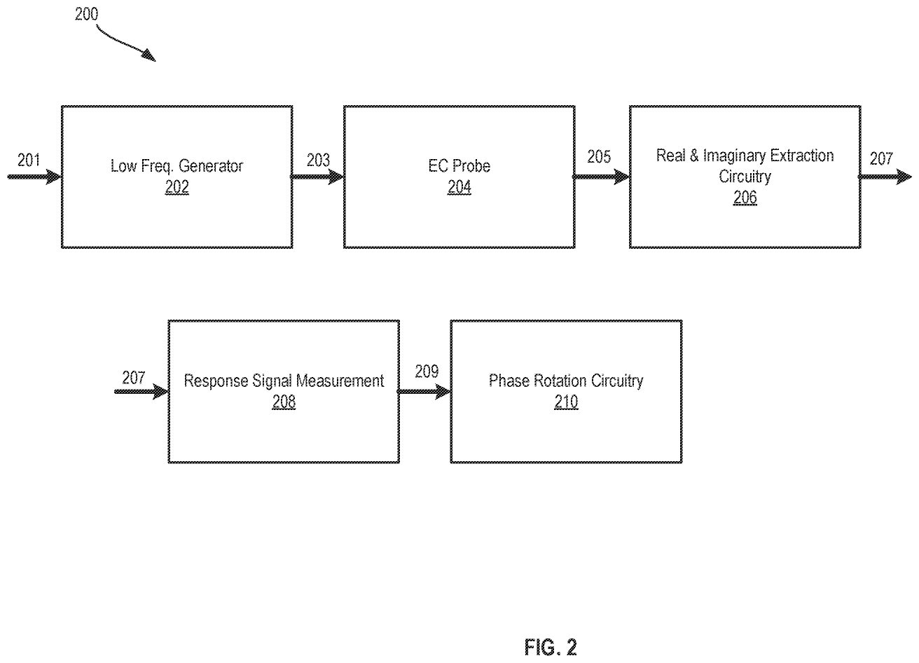

FIG. 2 is one exemplary flow diagram of a system for eddy current measurement and analysis for the detection of grinding burns on high strength steel through chrome plating, consistent with the present disclosure. In the example of FIG. 2, low frequency generator 202 is a frequency generator that is capable of being configured to generate AC signals in the appropriate frequency range to detect burns on steel under a chrome outer layer. In some embodiments, the appropriate frequency range is about 5 kHz to 100 kHz. The frequency to be used to scan the DUT is received by low frequency generator 202 via control signal 201. In some embodiments, the control signal 201 is received from a controller, such as computing device 110 from FIG. 1 above.

In response to receiving the control signal 201, low frequency generator 202 sets its output frequency to the desired scan frequency and sends low frequency output 203 to EC probe 204. EC probe 204 may be, for example, EC probe 135 from FIG. 1 above. EC probe 204 then injects this signal into the DUT, and senses changes to the eddy currents received from the DUT. The received eddy current response signal 205 is continuously decomposed into its real and imaginary components by the real and imaginary extraction circuitry 206. In some embodiments, this may be accomplished using two demodulators, one set to extract the sine component (it is used as one of the inputs, the other input is the signal of interest) and the other set to extract the cosine component of the input signal (it also is used as one of the inputs, the other input is again the signal of interest). The results 207 are input into the response signal measurement 206 where the response signals received by EC probe 204 are measured and accumulated.

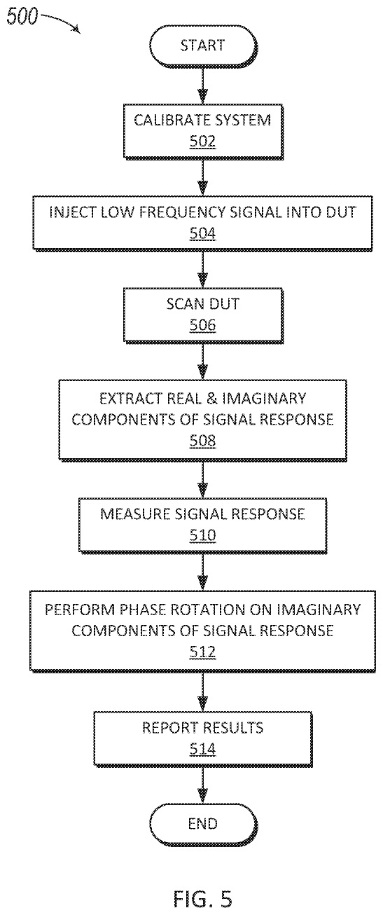

The real and imaginary components of the received signals are then sent to the phase rotation circuitry 210 via extracted data 209. The phase rotation is necessary to eliminate unwanted effects and highlight effects of interest. This is explained in FIG. 5 below.

In some embodiments, the phase rotation is accomplished by multiplying the complex signal by a complex unit vector. For example, if the real and imaginary components are assigned the variables a and b, respectively, the complex signal at a given data point can be represented as a+ib. To rotate the signal by phase θ to the new signal A+iB, the complex signal is multiplied by the complex unit vector cos(0)+i*sin(θ) i.e., A+iB=(a+ib)*(cos(θ)+i*sin(θ)) for every sampled point.

In some embodiments, the phase rotation may be performed by a controller, such as computing device 110 from FIG. 1 above. In some other embodiments, the phase rotation may be performed by specialized hardware, e.g., a Field Programmable Gate Array (FPGA). In some embodiments, the phase rotation may be performed by changing the phase of the cosine and sine components used as inputs into the demodulators. In yet another embodiments, the phase rotation may be performed by any other method as would be known to a person of skill in the art.

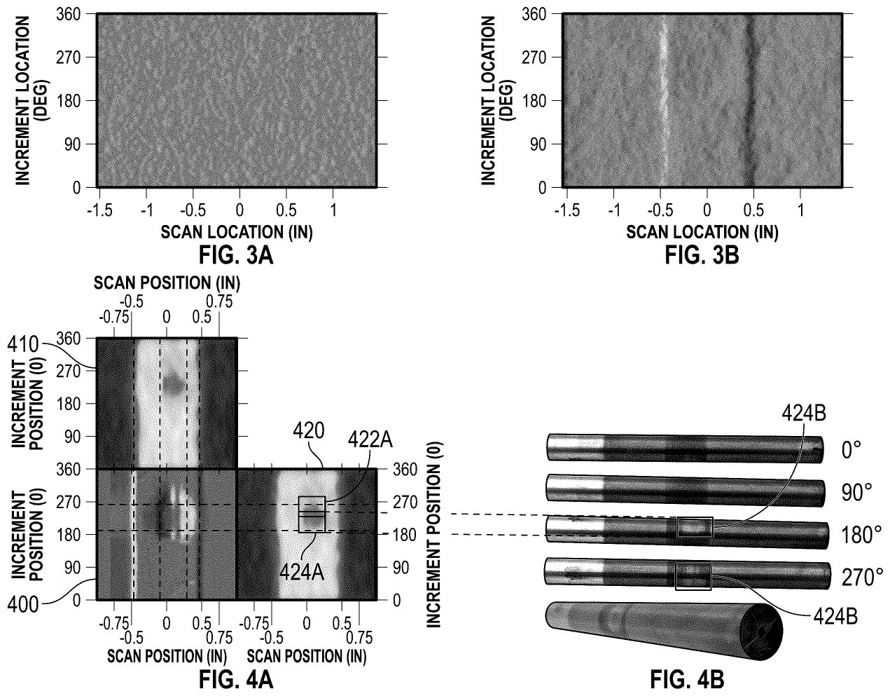

FIG. 4A is an example comparing probe outputs before and after chrome plating, consistent with the present disclosure. In the example scans of FIG. 4A, graph 400 represents the results of scanning the steel sample, with burn damage from grinding, prior to chrome plating, while graph 410 and graph 420 represent the results of scanning the steel sample after chrome plating.

FIG. 4B is an example comparing the results of FIG. 4A to a Nital etch result. In the example of FIG. 4A, the Nital etch was conducted before chrome plating. When using a Nital etch, dark areas are associated with OT burns, while lighter areas are associated with RH burns.

In graph 420 of FIG. 4A, the area highlighted by detail 422A indicates the damage caused by RH burning under the chrome plating. This corresponds to the area in detail 422B where the Nital etch resulted in a light area corresponding to RH burning. Likewise, in graph 420 of FIG. 4A, the area highlighted by detail 424A also indicates the damage caused by RH burning under the chrome plating. This corresponds to the area in detail 424B where the Nital etch resulted in a lighter area corresponding to RH burning.

FIG. 5 is a flowchart diagram depicting operations for the burn detection program 112, generally designated 500, for eddy current measurement and analysis for the detection of grinding burns on high strength steel through chrome plating, on the distributed data processing environment of FIG. 1, consistent with the present disclosure.

It should be appreciated that embodiments of the present disclosure provide at least for eddy current measurement and analysis for the detection of grinding burns on high strength steel through chrome plating. However, FIG. 5 provides only an illustration of one implementation and does not imply any limitations with regard to the environments in which different embodiments may be implemented. Many modifications to the depicted environment may be made by those skilled in the art without departing from the scope of the disclosure as recited by the claims.

The burn detection program 112 calibrates the system (operation 502). In the illustrated example embodiment, the burn detection program 112 calibrates the system to determine the phase rotation necessary to eliminate unwanted effects and highlight effects of interest. By calibrating the system prior to scanning the DUT, the burn detection program 112 maximizes the signal received from the EC probe, e.g., EC probe 135 from FIG. 1.

In some embodiments, the burn detection program 112 performs a calibration by scanning samples of known composition, e.g., type of steel, chrome plating depth, etc., that contain known defects, over a range of frequencies appropriate for the DUT. The sample preferably is of a similar composition to the DUT, including a plating thickness similar to the plating on the DUT. Once the burn detection program 112 has completed the calibration, the burn detection program 112 sets the phase and amplitude for the scan.

In some other embodiments, the calibration may be performed offline. In these embodiments, various samples are calibrated, and the results are categorized by factors that may include, but are not limited to, the type of base material, e.g., high-strength steel, the plating material, e.g., chrome, the thickness of the plating material, e.g., 3 mils, and the frequency that is selected on the frequency generator device, e.g., frequency generator device 120 from FIG. 1. Once all the results have been categorized, they are made available to the burn detection program 112 as, for example, a look-up table (LUT). In these embodiments, in operation 502 the burn detection program uses the LUT to determine the phase and amplitude settings for the scan.

The burn detection program 112 injects a low frequency signal into the DUT (operation 504). The burn detection program 112 determines the appropriate frequency of the signal to inject based on the properties of the DUT, such as material type, plating type, and plating thickness, along with the settings established in the calibration of operation 502. Once the burn detection program 112 has determined the appropriate frequency to inject into the DUT, the burn detection program 112 sends this frequency information to the frequency generator device and signals the frequency generator device to send a low frequency signal at the desired scan frequency to the scanning device, e.g., scanning device 130 from FIG. 1. The scanning device then injects the low frequency signal into the DUT using the EC probe, e.g., EC probe 135 from FIG. 1.

The burn detection program 112 scans the DUT (operation 506). The burn detection program 112 performs the scan of the DUT. In some embodiments, the scanning device is an automated scanning system, such as a linear scanning system, or a two-dimensional scanning system. In these embodiments, the burn detection program 112 signals the scanning device to perform the scan. In some other embodiments, the scanning device may consist of a manual EC probe, and a user moves the probe around the DUT.

The burn detection program 112 extracts the real & the imaginary components of the signal response (operation 508). The burn detection program 112 extracts the real and imaginary components of the EC signal response received from the scanning device, as is shown in FIGS. 3A and 3B above. As the scan of operation 506 is performed, the signal response data is received from the scanning device and the real and imaginary components of the received signal response data is continuously extracted.

The burn detection program separates the real components from the imaginary components because the response from surface cracks, which are prevalent in chrome plating, can be isolated via phase rotation to one of the axes. Allowing part or all of the response from permeability changes in the steel to be viewed on the other axis, free of noise from the microcracks. By extracting the real and the imaginary components from the received EC signal response, the burn detection program 112 can make these phase adjustments to highlight the potential damaged areas of the underlying steel.

The burn detection program 112 measures the signal response (operation 510). The burn detection program 112 receives the real and imaginary components of the EC signal response along with the position associated with each data point in the EC signal response.

The burn detection program 112 performs phase rotation on the orthogonal components of the signal response (operation 512). The burn detection program 112 uses the phase rotation determined in the calibration of operation 502 above to rotate the complete EC response from the scanning device to eliminate unwanted effects and highlight the effects of interest, e.g., a burn area on the underlying steel.

The burn detection program 112 reports the results (operation 514). The burn detection program 112 reports the results of the scan to the user. In some embodiments, the burn detection program 112 reports the results of the scan to the user in the form of one or more graphs, such as graph 410 and graph 420 of FIG. 4 above. In other embodiments, the burn detection program 112 may report the results of the scan to the user by any appropriate means as would be known to a person of skill in the art. The burn detection program 112 then ends for this cycle.

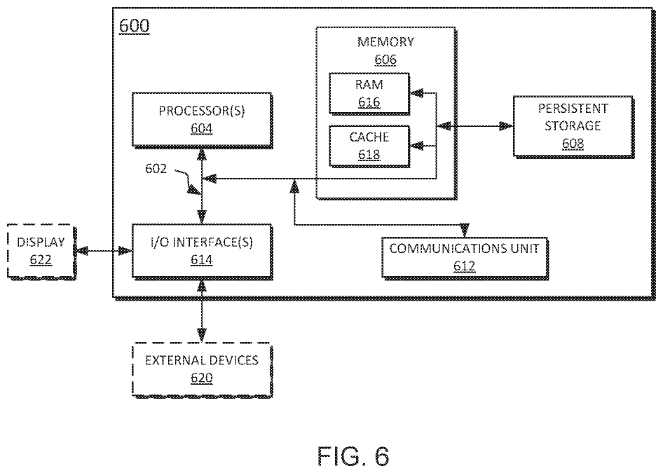

FIG. 6 is a block diagram depicting components of one example of the computing device 110 suitable for burn detection program 112, within the distributed data processing environment of FIG. 1, consistent with the present disclosure. FIG. 6 displays the computing device or computer 600, one or more processor(s) 604 (including one or more computer processors), a communications fabric 602, a memory 606 including, a random-access memory (RAM) 616 and a cache 618, a persistent storage 608, a communications unit 612, I/O interfaces 614, a display 622, and external devices 620. It should be appreciated that FIG. 6 provides only an illustration of one embodiment and does not imply any limitations with regard to the environments in which different embodiments may be implemented. Many modifications to the depicted environment may be made.

As depicted, the computer 600 operates over the communications fabric 602, which provides communications between the computer processor(s) 604, memory 606, persistent storage 608, communications unit 612, and input/output (I/O) interface(s) 614. The communications fabric 602 may be implemented with an architecture suitable for passing data or control information between the processors 604 (e.g., microprocessors, communications processors, and network processors), the memory 606, the external devices 620, and any other hardware components within a system. For example, the communications fabric 602 may be implemented with one or more buses.

The memory 606 and persistent storage 608 are computer readable storage media. In the depicted embodiment, the memory 606 comprises a RAM 616 and a cache 618. In general, the memory 606 can include any suitable volatile or non-volatile computer readable storage media. Cache 618 is a fast memory that enhances the performance of processor(s) 604 by holding recently accessed data, and near recently accessed data, from RAM 616.

Program instructions for burn detection program 112 may be stored in the persistent storage 608, or more generally, any computer readable storage media, for execution by one or more of the respective computer processors 604 via one or more memories of the memory 606. The persistent storage 608 may be a magnetic hard disk drive, a solid-state disk drive, a semiconductor storage device, flash memory, read only memory (ROM), electronically erasable programmable read-only memory (EEPROM), or any other computer readable storage media that is capable of storing program instruction or digital information.

The media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

The communications unit 612, in these examples, provides for communications with other data processing systems or devices. In these examples, the communications unit 612 includes one or more network interface cards. The communications unit 612 may provide communications through the use of either or both physical and wireless communications links. In the context of some embodiments of the present disclosure, the source of the various input data may be physically remote to the computer 600 such that the input data may be received, and the output similarly transmitted via the communications unit 612.

The I/O interface(s) 614 allows for input and output of data with other devices that may be connected to computer 600. For example, the I/O interface(s) 614 may provide a connection to external device(s) 620 such as a keyboard, a keypad, a touch screen, a microphone, a digital camera, and/or some other suitable input device. External device(s) 620 can also include portable computer readable storage media such as, for example, thumb drives, portable optical or magnetic disks, and memory cards. Software and data used to practice embodiments of the present disclosure, e.g., burn detection program 112, can be stored on such portable computer readable storage media and can be loaded onto persistent storage 608 via the I/O interface(s) 614. I/O interface(s) 614 also connect to a display 622.

Display 622 provides a mechanism to display data to a user and may be, for example, a computer monitor. Display 622 can also function as a touchscreen, such as a display of a tablet computer.

According to one aspect of the disclosure there is thus provided a system for detection of grinding burns on high strength steel through chrome plating comprising: a frequency generator device; a scanning device; one or more computer processors; one or more non-transitory computer readable storage media; and program instructions stored on the one or more non-transitory computer readable storage media for execution by at least one of the one or more computer processors, the stored program instructions including instructions to: calibrate the system; inject a low frequency signal into a Device Under Test (DUT); scan the DUT and receive a resulting eddy current (EC) signal response; extract one or more real components and one or more imaginary components of the resulting EC signal response; and perform a phase rotation on the one or more orthogonal components of the resulting EC signal response to highlight one or more effects of interest.

According to another aspect of the disclosure, there is provided a computer-implemented method for detection of grinding burns on high strength steel through chrome plating, comprising: calibrating, by one or more computer processors, a system; injecting, by the one or more computer processors, a low frequency signal into a Device Under Test (DUT); scanning, by the one or more computer processors, the DUT and receive a resulting eddy current (EC) signal response; extracting, by the one or more computer processors, one or more real components and one or more imaginary components of the resulting EC signal response; and performing, by the one or more computer processors, a phase rotation on the one or more orthogonal components of the resulting EC signal response to highlight one or more effects of interest.

According to yet another aspect of the disclosure, there is provided a computer program product for detection of grinding burns on high strength steel through chrome plating that includes one or more non-transitory computer readable storage media and program instructions stored on the one or more non-transitory computer readable storage media that, when executed by one or more computer processors, cause the one or more computer processors to perform operations comprising: calibrate a system; inject a low frequency signal into a Device Under Test (DUT); scan the DUT and receive a resulting eddy current (EC) signal response; extract one or more real components and one or more imaginary components of the resulting EC signal response; and perform a phase rotation on the one or more orthogonal components of the resulting EC signal response to highlight one or more effects of interest.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-exhaustive list of more specific examples of the one or more non-transitory computer readable storage media includes the following: a portable computer diskette, a hard disk, a RAM, a ROM, an EPROM or Flash memory, a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A non-transitory computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

Computer readable program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in one or more non-transitory computer readable storage media that can direct a computer, a programmable data processing apparatus, and/or other devices to function in a particular manner, such that the one or more non-transitory computer readable storage media having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

1. A system for detection of grinding burns on high strength steel through chrome plating, the system comprising:
a frequency generator device;
a scanning device;
one or more computer processors;
one or more non-transitory computer readable storage media; and
program instructions stored on the one or more non-transitory computer readable storage media for execution by at least one of the one or more computer processors, the stored program instructions including instructions to:
calibrate the system;
inject, using the frequency generator device, a low frequency signal into a Device Under Test (DUT);
scan, using the scanning device, the DUT and receive a resulting eddy current (EC) signal response;
move the frequency generator device and the scanning device at a constant speed relative to the DUT;
extract one or more real components and one or more imaginary components of the resulting EC signal response, and determine a position along the DUT of each of the extracted one or more real components and one or more imaginary components; and
perform a phase rotation on the one or more real components and one or more imaginary components of the resulting EC signal response at each determined position along the DUT to highlight one or more effects of interest.

2. The system of claim 1, wherein the scanning device further comprises an EC probe.

3. The system of claim 2, wherein the EC probe is selected from a group consisting of a reflection probe, a differential probe, a hybrid probe, and a split D probe.

4. (canceled)

5. The system of claim 1, wherein calibrating the system further comprises one or more of the following program instructions, stored on the one or more non-transitory computer readable storage media, to:
scan one or more samples of a known composition; and
determine the phase rotation and an amplitude based on scanning of the one or more samples of the known composition; wherein:
the one or more samples have a composition that is similar to the DUT,
the one or more samples have a plating thickness that is similar to the DUT, and
the one or more samples are scanned over a range of frequencies from about 5 kilohertz (kHz) to 100 kHz.

6. The system of claim 1, wherein calibrating the system further comprises one or more of the following program instructions, stored on the one or more non-transitory computer readable storage media, to:
scan a plurality of samples of a known composition; and
compile a look-up table of results of the scan of the plurality of samples of the known composition.

7. The system of claim 1, wherein injecting the low frequency signal into the DUT further comprises one or more of the following program instructions, stored on the one or more non-transitory computer readable storage media, to:
receive a signal from the one or more computer processors that contains a desired scan frequency;
generate an alternating current (AC) signal at the desired scan frequency; and
send the AC signal at the desired scan frequency to the scanning device.

8-14. (canceled)

15. A computer program product for detection of grinding burns on high strength steel through chrome plating that includes one or more non-transitory computer readable storage media and program instructions stored on the one or more non-transitory computer readable storage media that, when executed by one or more computer processors, cause the one or more computer processors to perform operations, comprising:
calibrate a system;
inject a low frequency signal into a Device Under Test (DUT);
scan, using an eddy current (EC) probe, the DUT and receive a resulting EEC signal response;
move the EC probe at a constant speed relative to the DUT;
extract one or more real components and one or more imaginary components of the resulting EC signal response, and determine a position along the DUT of each of the extracted one or more real components and one or more imaginary components; and
perform a phase rotation on the one or more real components and one or more imaginary components of the resulting EC signal response at each determined position along the DUT to highlight one or more effects of interest.
extract one or more real components and one or more imaginary components of the resulting EC signal response; and
perform a phase rotation on the one or more orthogonal components of the resulting EC signal response to highlight one or more effects of interest.

16. The computer program product of claim 15, wherein calibrating the system further comprises one or more of the following program instructions, stored on the one or more non-transitory computer readable storage media, to:
scan one or more samples of a known composition; and
determine the phase rotation and an amplitude based on scanning of the one or more samples of the known composition; wherein:
the one or more samples have a composition that is similar to the DUT,
the one or more samples have a plating thickness that is similar to the DUT, and
the one or more samples are scanned over a range of frequencies from about 5 kilohertz (kHz) to 100 kHz.

17. The computer program product of claim 15, wherein calibrating the system further comprises one or more of the following program instructions, stored on the one or more non-transitory computer readable storage media, to:
scan a plurality of samples of a known composition; and
compile a look-up table of results of the scan of the plurality of samples of the known composition.

18. The computer program product of claim 15, wherein injecting the low frequency signal into the DUT further comprises one or more of the following program instructions, stored on the one or more non-transitory computer readable storage media, to:
receive a signal from the one or more computer processors that contains a desired scan frequency;
generate an alternating current (AC) signal at the desired scan frequency; and
inject the AC signal at the desired scan frequency into the DUT.

19. The computer program product of claim 15, wherein the EC probe is selected from a group consisting of a reflection probe, a differential probe, a hybrid probe, and a split D probe.

20. (canceled)
